(19) United States
(12) Patent Application Publication
(10) Pub. No.: US 2025/0130167 A1
(43) Pub. Date: Apr. 24, 2025

(54) COMPUTER DEVICE AND METHOD FOR EXAMINING A RADAR SYSTEM EQUIPPED WITH AT LEAST TWO TRANSMITTING AND RECEIVING UNITS, EACH HAVING AT LEAST TWO ANTENNA ELEMENTS

(71) Applicant: Robert Bosch GmbH, Stuttgart (DE)

(72) Inventors: Daniel Schindler, Korntal-Münchingen (DE); Tobias Schmid, Fluorn-Winzeln (DE); Benedikt Loesch, Stuttgart (DE); Johannes Fink, Karlsruhe (DE); Werner Soergel, Pforzheim (DE)

(21) Appl. No.: 18/830,979

(22) Filed: Sep. 11, 2024

(30) Foreign Application Priority Data
Sep. 22, 2023 (DE) 102023209254.9

(51) Int. Cl. G01S 7/40; G01S 13/00

(52) U.S. Cl. CPC G01N 21/6456; G01N 21/88

(57) ABSTRACT

A computer device and method for examining a radar system equipped with at least two transmitting and receiving units, each having at least two antenna elements. The method includes: selecting a first radar signal, emitted by a first transmitting and receiving unit of the radar system and received by a second transmitting and receiving unit of the radar system, and a second radar signal, which is emitted by the second transmitting and receiving unit and received by the first transmitting and receiving unit, ascertaining a phase difference between the first radar signal and the second radar signal and specifying alignment information with regard to a relative tilt of the first transmitting and receiving unit in relation to the second transmitting and receiving unit, taking into account the ascertained phase difference.

### FIELD

The present invention relates to a computer device for a radar system equipped with at least two transmitting and receiving units, each having at least two antenna elements, and to a radar system. The present invention also relates to a method for examining a radar system equipped with at least two transmitting and receiving units, each having at least two antenna elements. Furthermore, the present invention relates to a method for operating a radar system equipped with at least two transmitting and receiving units, each having at least two antenna elements, and to a method for determining environmental information with regard to at least a partial environment of a radar system equipped with at least two transmitting and receiving units, each having at least two antenna elements.

### BACKGROUND INFORMATION

Radar sensor systems, in particular cooperative radar sensor systems, are described in the related art, such as German Patent Application No. DE 10 2019 220 238 A1.

### SUMMARY

The present invention provides a computer device for a radar system having at least two transmitting and receiving units, each having at least two antenna elements, a radar system, a method for examining a radar system having at least two transmitting and receiving units, each having at least two antenna elements, a method for operating a radar system equipped with at least two transmitting and receiving units, each having at least two antenna elements, and a method for determining environmental information with regard to at least a partial environment of a radar system equipped with at least two transmitting and receiving units, each having at least two antenna elements.

The present invention provides advantageous possibilities for detecting a tilt of at least one transmitting and receiving unit of a radar system equipped with at least two transmitting and receiving units, each having at least two antenna elements, from its predetermined target alignment. By means of the present invention, it is thus possible to identify the incorrect assembly of the at least two transmitting and receiving units of the relevant radar system, damage to the radar system, for example due to mechanical contact with a foreign object, and/or impairment of the relevant radar system due to environmental influences, such as in particular due to heat or wind load on the bumper. By means of the present invention, measures can then be carried out by means of which the tilt of the at least one transmitting and receiving unit can be corrected and/or compensated for by means of a correspondingly adapted operation of the relevant radar system. The present invention can therefore be used not only to detect the tilt of the at least one transmitting and receiving unit of the relevant radar system, but also to advantageously react to this detected error. The present invention thus contributes to improving an operation of the relevant radar system, to performing an online calibration of the relevant radar system and to increasing the service life of the relevant radar system.

In an advantageous example embodiment of the computer device for a radar system equipped with n transmitting and receiving units, each having at least two antenna elements, with n being a natural number greater than or equal to 3, the electronic device is designed and/or programmed such that, by means of the electronic device, from the plurality of radar signals transmitted and received by means of the radar system, for each of the n transmitting and receiving units as the relevant first transmitting and receiving unit and each of the n−1 further transmitting and receiving units as the relevant second receiving unit, the relevant first radar signal and the relevant second radar signal can be selected, for which it can be recognized or read out by means of the stored information that, in the case of the transmitting and receiving units of the radar system being present without a tilt, the probable first optical length of the relevant first signal path of the relevant first radar signal is equal to the probable second optical length of the relevant second signal path of the relevant second radar signal, wherein, by means of the electronic device, taking into account the relevant phase difference between the relevant first radar signal and the relevant second radar signal the alignment information with regard to the relevant relative tilt of the relevant first transmitting and receiving unit in relation to the relevant second transmitting and receiving unit can be specified. Thus, by means of the embodiment described here, (n*(n−1)) relative tilts of the n transmitting and receiving units of the radar system with respect to one another can be reliably determined.

Preferably, according to an example embodiment of the present invention, the electronic device is designed and/or programmed such that, if for at least two transmitting and receiving units a relative tilt with respect to one another equal to zero is specified as at least part of the alignment information, by means of the electronic device at least one of the at least two transmitting and receiving units with the relative tilt with respect to one another equal to zero can be selected as the reference unit, an absolute tilt of the at least one reference unit with respect to a predetermined target alignment equal to zero can be specified as part of the alignment information, and, if at least one of the transmitting and receiving units is not selected as a reference unit, a relative tilt of the at least one transmitting and receiving unit not selected as a reference unit in relation to the at least one reference unit can be specified as an absolute tilt of the relevant transmitting and receiving unit with respect to the predetermined target alignment as part of the alignment information. The embodiment of the computer device described here can thus ascertain n absolute tilts of the n transmitting and receiving units with respect to their predetermined target alignment based on the (n*(n−1)) determined relative tilts of the n transmitting and receiving units with respect to one another.

As an advantageous development of the present invention, the electronic device can be designed and/or programmed such that, by means of the electronic device, at least one control signal can be output to a separate alignment device of the relevant transmitting and receiving unit for at least one of the transmitting and receiving units, taking into account the specified alignment information with regard to their relevant absolute tilt with respect to the predetermined target alignment, such that an actual alignment of the relevant transmitting and receiving unit can be adjusted by means of the controlled alignment device in accordance with the target alignment. By means of the computer device described here, at least one detected absolute tilt of at least one of the transmitting and receiving units of the relevant radar system in accordance with its predetermined target alignment can therefore be corrected by appropriately controlling the associated alignment device.

Alternatively or additionally, the electronic device of the present invention can be designed and/or programmed such that environmental information with regard to at least a partial environment of the radar system can be specified by means of the electronic device taking into account the plurality of radar signals transmitted and received by means of the radar system and additionally taking into account a predetermined evaluation program, wherein the evaluation program can be redefined by means of the electronic device, taking into account the specified alignment information with regard to the relative tilt of the relevant first transmitting and receiving unit in relation to the relevant second transmitting and receiving unit and/or with regard to the relevant absolute tilt of each transmitting and receiving unit with respect to the predetermined target orientation. By redefining the evaluation program in the embodiment of the computer device described here, a tilt of at least one transmitting and receiving unit of the relevant radar system can be compensated for during an evaluation of transmitted and received radar signals. In this way, error-free continued operation of the radar system can be ensured, which (essentially) corresponds to its target operation when all of its transmitting and receiving units are present without a tilt.

For example, according to an example embodiment of the present invention, the relevant first radar signal can be emitted by a first antenna element of the relevant first transmitting and receiving unit, reflected at the object position and received by a second antenna element of the relevant second transmitting and receiving unit, and the relevant second radar signal can be emitted by a third antenna element of the second transmitting and receiving unit, reflected at the object position and received by a fourth antenna element of the first transmitting and receiving unit. This allows a plurality of selection options for the relevant first transmit and receive signal and the associated second transmit and receive signal.

Preferably, according to an example embodiment of the present invention, in the case of the relevant first transmitting and receiving unit and the relevant second transmitting and receiving unit being present without a tilt, a first vector from the first antenna element of the relevant first transmitting and receiving unit to the fourth antenna element of the first transmitting and receiving unit is equal to a second vector from the third antenna element of the relevant second transmitting and receiving unit to the second antenna element of the second transmitting and receiving unit. A tilt of the relevant first transmitting and receiving unit and/or the relevant second transmitting and receiving unit then automatically causes a change in the phase difference between the first radar signal and the second radar signal, by means of which the tilt can be clearly and reliably detected.

A radar system according to the present invention having a corresponding computer device and the at least two transmitting and receiving units, each having at least two antenna elements, also has the advantages described above. The radar system can be, for example, a radar sensor system and/or a cooperative radar sensor system. The radar system can thus for example also be a system having an evaluation unit and various remote antenna arrays having transmitting and receiving antennas, or a central processing unit having such antenna arrays. The radar system can likewise also be a cooperative system comprising various synchronized radar sensors.

Likewise, carrying out a corresponding method of the present invention for examining a radar system equipped with at least two transmitting and receiving units, each having at least two antenna elements, also brings about the advantages explained above. It is pointed out that the method can be further developed in accordance with the embodiments (explained above) of the computer device.

Furthermore, a method according to the present invention for operating a radar system equipped with at least two transmitting and receiving units, each having at least two antenna elements, and a method for determining environmental information with regard to at least a partial environment of a radar system equipped with at least two transmitting and receiving units, each having at least two antenna elements, also provide the advantages explained above. These methods can also be further developed according to the embodiments of the computer device described above.

### BRIEF DESCRIPTION OF THE DRAWINGS

Further features and advantages of the present invention will be explained in the following with reference to the figures.

FIGS. 1A and 1B is a schematic representation of a radar system having at least two transmitting and receiving units, each having at least two antenna elements, and a flow chart for explaining a first embodiment of the method for examining the radar system;

FIG. 2 is a schematic representation of a radar system having at least three transmitting and receiving units, each having at least two antenna elements, for explaining a second embodiment of the method for examining the radar system;

FIG. 3 is a flow chart for explaining the method for operating a radar system equipped with at least two transmitting and receiving units, each having at least two antenna elements;

FIG. 4 is a flow chart for explaining an embodiment of the method for determining environmental information with regard to at least a partial environment of a radar system equipped with at least two transmitting and receiving units, each having at least two antenna elements; and

FIG. 5A to 5C are schematic partial representations of a radar system equipped with at least two transmitting and receiving units, each having at least two antenna elements, and a coordinate system for explaining an embodiment of a computer device interacting therewith.

### DETAILED DESCRIPTION OF EXAMPLE EMBODIMENTS

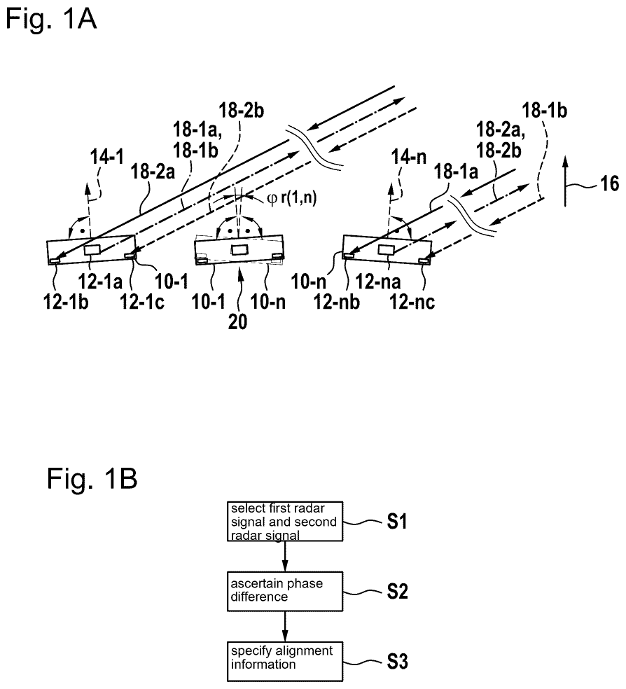

FIGS. 1A and 1B are schematic representations of a radar system having at least two transmitting and receiving units, each having at least two antenna elements, and a flow chart for explaining a first embodiment of the method for examining the radar system.

The radar system shown schematically in FIG. 1A has at least two transmitting and receiving units 10-1 to 10-n, wherein each of the at least two transmitting and receiving units 10-1 to 10-n have at least two antenna elements 12-1a to 12-na, 12-1b to 12-nb and 12-1c to 12-nc. The pictorial representation of only two transmitting and receiving units 10-1 to 10-n in FIG. 1A is to be interpreted as being only by way of example. The at least two transmitting and receiving units 10-1 to 10-n can optionally have an equal total number of antenna elements 12-1a to 12-na, 12-1b to 12-nb and 12-1c to 12-nc (per transmitting and receiving unit 12-1 to 12-n) or can differ in their total number of antenna elements 12-1a to 12-na, 12-1b to 12-nb and 12-1c to 12-nc (per transmitting and receiving unit 12-1 to 12-n). However, the at least two transmitting and receiving units 10-1 to 10-n are to be understood as units of which each is designed/suitable for both transmitting and receiving radar signals.

The at least two transmitting and receiving units 10-1 to 10-n of the radar system are understood to be spatially separated units. The at least two transmitting and receiving units 10-1 to 10-n can, for example, be sub-devices of the radar system, which are not mounted on a common carrier. Alternatively, the at least two transmitting and receiving units 10-1 to 10-n can also be mounted on a common carrier (not shown). In the monostatic case of operation of the radar system, a radar signal transmitted by a single transmitting and receiving unit 10-1 or 10-n is received and evaluated by the same transmitting and receiving unit 10-1 to 10-n after it has been reflected on an object. In the bistatic case of operation, the radar signal can be received by another transmitting and receiving unit 10-1 to 10-n, even after it has been reflected on the object.

As illustrated in FIG. 1A, at least one of the transmitting and receiving units 10-1 to 10-n can also be tilted with respect to its predetermined target alignment or deflected/rotated out of its predetermined target alignment. For example, for the at least two transmitting and receiving units 10-1 to 10-n, an alignment may be preferred in which a relevant main transmitting and main receiving direction 14-1 to 14-n of the at least two transmitting and receiving units 10-1 to 10-n is aligned parallel to a predetermined target direction 16. In contrast, in the example of FIG. 1A, the transmitting and receiving units 10-1 to 10-n are “rotated” with respect to their predetermined target alignment such that their respective main transmitting and main receiving directions 14-1 to 14-n are aligned in a manner inclined relative to the target direction 16 (by an angle not equal to zero). This can also be described as the antenna elements 12-1a to 12-na, 12-1b to 12-nb and 12-1c to 12-nc not lying on a continuous line, but being tilted with respect to the continuous line. The state illustrated in FIG. 1A can result from improper assembly of the radar system, damage to the radar system, for example due to impact with a foreign object, or environmental influences, such as in particular thermal stress.

However, it is expressly pointed out that implementability of the method described here does not require the target alignments of the at least two transmitting and receiving units 10-1 to 10-n to be specified such that their main transmitting and main receiving directions 14-1 to 14-n are aligned parallel to a predetermined target direction 16. Instead, the method described here can also be carried out if, when the at least two transmitting and receiving units 10-1 to 10-n having their target alignments are present, their main transmitting and main receiving directions 14-1 to 14-n are aligned in different directions.

A possible tilt of at least one of the transmitting and receiving units 10-1 to 10-n of the radar system can be reliably detected by means of the method described below and/or quantitatively determined by means of a corresponding physical quantity and then corrected:

For this purpose, when carrying out the method, in a method step S1 (see FIG. 1B) at least a first radar signal 18-1a and a respectively associated second radar signal 18-2a are selected from a plurality of radar signals 18-1a, 18-1b, 18-2a and 18-2b transmitted and received by means of the radar system. The at least one first radar signal 18-1a is understood in each case to be a radar signal emitted by a first transmitting and receiving unit 10-1 of the radar system, reflected at an object position outside the radar system (not shown) and received by a second transmitting and receiving unit 10-n of the radar system. Accordingly, the respectively associated second radar signal 18-2a is to be understood as a radar signal emitted by the second transmitting and receiving unit 10-n, reflected at the (same) object position and received by the first transmitting and receiving unit 10-1. Preferably, the object position at which the radar signals 18-1a and 18-2a mentioned here are reflected is located in a far field of the radar system. In addition, the at least one first radar signal 18-1a and the respectively associated second radar signal 18-2a are selected such that, in the case of the transmitting and receiving units 10-1 to 10-n of the radar system being present without a tilt, a probable first optical length of a relevant first signal path of the first radar signal 18-1a is equal to a probable second optical length of a relevant second signal path of the relevant second radar signal 18-2a, or the difference in the optical length is known when the sensors are intentionally aligned in a non-target direction 16.

In the example described here, the relevant first radar signal 18-1a is emitted by a first antenna element 12-1a of the relevant first transmitting and receiving unit 10-a, reflected at the object position, and received by a second antenna element 12-nb of the relevant second transmitting and receiving unit 10-n, while the relevant second radar signal 18-2a is emitted by a third antenna element 12-na of the second transmitting and receiving unit 10-n, reflected at the object position, and received by a fourth antenna element 12-1b of the first transmitting and receiving unit 10-1. From FIG. 1A it can be seen that, when the relevant first transmitting and receiving unit 10-1 and the relevant second transmitting and receiving unit 10-n are present without a tilt, a first vector from the first antenna element 12-1a to the fourth antenna element 12-1b is equal to a second vector from the third antenna element 12-na to the second antenna element 12-nb.

In the example of FIG. 1A, in the case of the transmitting and receiving units 10-1 to 10-n being present without a tilt, the probable optical length of the signal path of the radar signal 18-1a transmitted by the antenna element 12-1a of the transmitting and receiving unit 10-1, reflected at the object position, and received by the antenna element 10-nb of the transmitting and receiving unit 10-n, would be equal to the probable optical length of the signal path of the radar signal 18-2a transmitted by the antenna element 12-na, reflected at the object position, and received by the antenna element 12-1b. Accordingly, in the case of the transmitting and receiving units 10-1 to 10-n being present without a tilt, the probable optical length of a signal path of a radar signal 18-1b transmitted by the antenna element 12-1a of the transmitting and receiving unit 10-1, reflected at the object position, and received by an antenna element 12-nc of the transmitting and receiving unit 10-n, would be equal to the probable optical length of a signal path of a radar signal 18-2b transmitted by the antenna element 12-na, reflected at the object position, and received by an antenna element 12-1c of the transmitting and receiving unit 10-1.

FIG. 1A also shows a projection 20 of the two transmitting and receiving units 10-1 and 10-n on top of each other. (The projection 20 can also be understood as a virtual bistatic antenna array.) As can be seen from the projection 20, a tilt of the two transmitting and receiving units 10-1 and 10-n relative to one another causes the (actual) optical length l₁₈₋₁ₐ of the signal path of the radar signal 18-1a to deviate from the (actual) optical length l₁₈₋₂ₐ of the signal path of the radar signal 18-2a. Accordingly, the (actual) optical lengths of the signal paths of the radar signals 18-1b and 18-2b also differ from one another. By means of a bistatic evaluation of the radar signals 18-1a and 18-1b, a phase difference ΔΦ of the phases of the complex spectral values between the radar signals 18-1a and 18-2a can therefore be determined. By means of a corresponding evaluation, a phase difference 4@ between the radar signals 18-1b and 18-2b can also be ascertained. Accordingly, phase differences ΔΦ of other radar signals (not shown) can also be determined.

The phase difference ΔΦ (18-1a, 18-2a) between the radar signals 18-1a and 18-2a is, for example, defined, according to equation (Eq. 1) with:

$$Δ ∅ ( 18 - 1 a , 18 - 2 a ) = \frac{2 π}{λ} * ( {l}_{18 - 1 a} - {l}_{18 - 2 a} ) , \qquad ( Eq . 1 )$$

where λ is the wavelength of the radar signals 18-1b and 18-2b.

Therefore, when carrying out the method described here, the relevant phase difference ΔΦ between the relevant first radar signal 18-1a or 18-1b and the respectively associated second radar signal 18-2a or 18-2b is ascertained in a method step S2. Subsequently, in a method step S3, alignment information φr (1, n) with regard to a relative tilt of the relevant first transmitting and receiving unit 10-1 in relation to the respectively associated second transmitting and receiving unit 10-n is specified, taking into account the ascertained phase difference ΔΦ, or its possible deviation from a predetermined output phase difference. Thus, the relevant phase difference ΔΦ between the relevant first radar signal 18-1a or 18-1b and the respectively associated second radar signal 18-2a or 18-2b can be used to demonstrate a possible tilt of the first transmitting and receiving unit 10-1 in relation to the second transmitting and receiving unit 10-n and/or to express this quantitatively by means of a corresponding physical quantity or (1, n). Whenever a phase difference ΔΦ deviating from the predetermined output phase difference is determined, it can be reliably assumed that the two transmitting and receiving units 10-1 and 10-n are actually tilted with respect to one another. This allows an easily implementable method to be used for the reliable detection of a possible tilt of the two transmitting and receiving units 10-1 and 10-n with respect to one another. As a physical quantity or (1, n) with regard to the relative tilt of the transmitting and receiving units 10-1 and 10-n with respect to one another, for example an inclination angle or (1, n) between the two main transmitting and receiving directions 14-1 and 14-n of the two transmitting and receiving units 10-1 and 10-n can be specified.

The transmitting and receiving units 10-1 and 10-n, which are present according to their target alignments, can in particular be aligned with one another such that the predetermined output phase difference is equal to zero. Alternatively, the transmitting and receiving units 10-1 and 10-n can also be positioned relative to one another according to their target alignments so that the predetermined output phase difference deviates from zero. This is the case, for example, if the transmitting and receiving units 10-1 and 10-n are in each case a corner sensor and a front sensor, which, when present, are aligned with one another at an inclination angle not equal to zero, according to their target alignments.

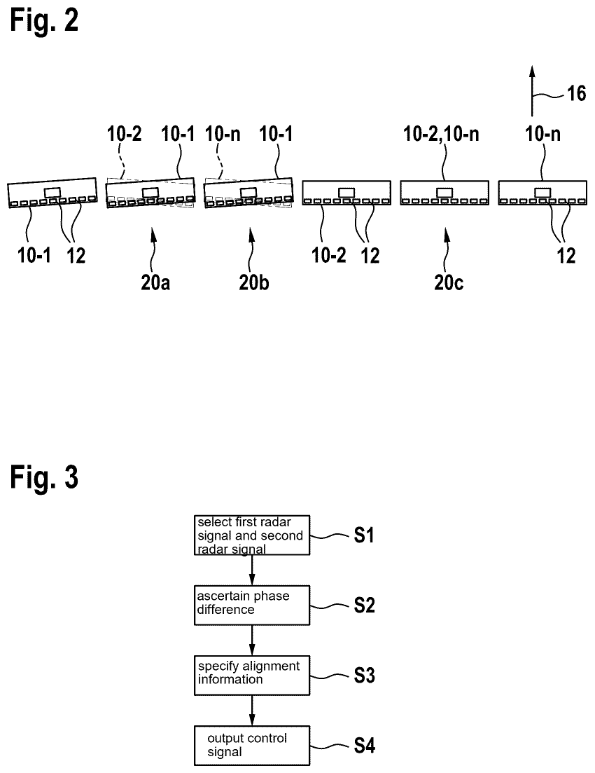

FIG. 2 is a schematic representation of a radar system having at least three transmitting and receiving units, each having at least two antenna elements, for explaining a second embodiment of the method for examining the radar system.

The method described below can be carried out using (almost) any radar system which has n transmitting and receiving units 10-1, 10-2 to 10-n, each having at least two antenna elements 12, where n is a natural number greater than or equal to 3.

In the method described here, first (when carrying out the method steps already explained above) from the plurality of radar signals transmitted and received by means of the radar system, for each of the n transmitting and receiving units 10-1, 10-2 to 10-n as the relevant first transmitting and receiving unit and each of the n−1 further transmitting and receiving units 10-1, 10-2 to 10-n as the relevant second receiving unit, the relevant first radar signal and the relevant second radar signal are selected such that, in the case of the transmitting and receiving units 10-1, 10-2 to 10-n of the radar system being present without a tilt, a probable first optical length of the relevant first signal path of the relevant first radar signal is equal to a probable second optical length of the relevant second signal path of the relevant second radar signal. Subsequently, taking into account a relevant phase difference between the relevant first radar signal and the relevant second radar signal, the alignment information with regard to a relevant relative tilt of the relevant first transmitting and receiving unit in relation to the relevant second transmitting and receiving unit is specified.

By means of the method steps explained above, for the n transmitting and receiving units 10-1, 10-2 to 10-n of the radar system (n*(n−1)) relative tilts of the transmitting and receiving units 10-1, 10-2 to 10-n of the radar system with respect to one another are obtained. For pairs of transmitting and receiving units 10-1, 10-2 to 10-n that are not tilted with respect to one another, the determined phase difference is equal to the predetermined output phase difference, i.e., in the example described here equal to 0°. (If the phase signals of individual channels are additionally noisy, the phase differences are not exactly on the same plane. However, in this case the phase differences are distributed with a statistical deviation from one another, such as Gaussian distribution, and can be extrapolated into a plane.)

If for at least two transmitting and receiving units 10-2 and 10-n a relative tilt with respect to one another equal to zero is specified, and/or the tilt is desired and known, the absolute tilts of the individual transmitting and receiving units 10-1 to 10-n with respect to the predetermined target alignment can also be determined. In the example of FIG. 2, it can be seen from a projection 20a of the transmitting and receiving unit 10-1 and the transmitting and receiving unit 10-2 on one another, and from a projection 20b of the transmitting and receiving unit 10-1 and the transmitting and receiving unit 10-n on one another, that the transmitting and receiving unit 10-1 has a relative tilt not equal to zero in relation to the transmitting and receiving unit 10-2 and a relative tilt not equal to zero in relation to the transmitting and receiving unit 10-n. In contrast, it can be seen from a projection 20c that the transmitting and receiving unit 10-2 is not tilted in relation to the transmitting and receiving unit 10-n. From this it can be reliably concluded that the transmitting and receiving units 10-2 and 10-n are still in their relevant target alignment.

In the method described here, therefore, at least one of the at least two transmitting and receiving units 10-2 and 10-n with the relative tilt with respect to one another equal to zero, or a known and desired tilt, is selected as the reference unit 10-2 or 10-n. An absolute tilt of the at least one reference unit 10-2 or 10-n with respect to the predetermined target alignment (as part of the alignment information) is then specified as equal to zero or desired. If at least one of the transmitting and receiving units 10-1 is not selected as a reference unit, a relative tilt of the at least one transmitting and receiving unit 10-1 not selected as a reference unit in relation to the at least one reference unit 10-2 or 10-n is then specified as an absolute tilt of the relevant transmitting and receiving unit 10-1 with respect to the predetermined target alignment (as part of the alignment information). In this way, the absolute tilt of all the transmitting and receiving units 10-1, 10-2 to 10-n of the radar system with respect to the predetermined target alignment can also be determined.

This method can also be applied on a rolling basis. Preferably, one sensor is alternately compared against all other n−1 sensors. If the tilt is detected in all bistatic virtual sensors involving the “sensor under test” and the ascertained tilt angle is identical for all samples, this sensor can be identified as the cause of the relative tilt. Furthermore, this method can be applied to all combinations of less than n−1 sensors against the “sensor under test” if more than one sensor is tilted.

Alternatively, each of the transmitting and receiving units 10-1, 10-2 to 10-n can also be assigned a “boresight confidence” using a histogram method, a two-point method or a three-point method. The transmitting and receiving unit 10-1, 10-2 to 10-n with the highest boresight confidence can then be used as the reference unit. Thereafter, an absolute tilt of the at least one reference unit with respect to the predetermined target alignment equal to zero can be specified. If at least one of the transmitting and receiving units 10-1 is not selected as a reference unit, a relative tilt of the at least one transmitting and receiving unit not selected as a reference unit in relation to the at least one reference unit can be specified as an absolute tilt of the relevant transmitting and receiving unit with respect to the predetermined target alignment.

FIG. 3 is a flow chart for explaining the method for operating a radar system equipped with at least two transmitting and receiving units, each having at least two antenna elements.

In the method described here, at least the method steps S1 to S3 already explained above are first carried out in order to specify the relevant absolute tilt of each of the transmitting and receiving units with respect to the predetermined target alignment as alignment information based on the data obtained in the process.

In a further method step S4, at least one control signal is then output for at least one of the transmitting and receiving units to a separate alignment device of the relevant transmitting and receiving unit. The output of at least one control signal occurs taking into account the relevant specified absolute tilt of the relevant transmitting and receiving unit with respect to the predetermined target alignment. In this way, an actual alignment of the relevant transmitting and receiving unit is adjusted by means of the controlled alignment device in accordance with the target alignment. Therefore, using the method described here, “errors” in the alignment of at least one of the transmitting and receiving units can be corrected again.

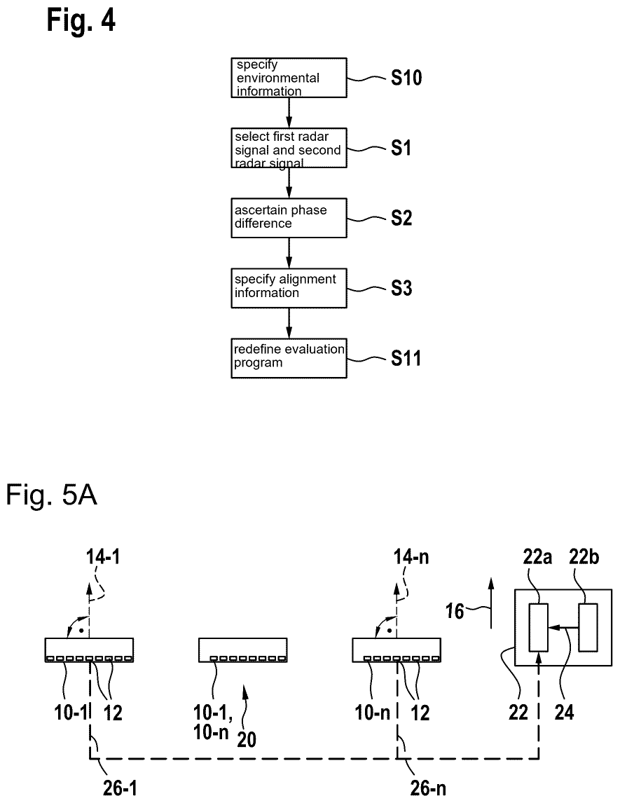

FIG. 4 is a flow chart for explaining an embodiment of the method for determining environmental information with regard to at least a partial environment of a radar system equipped with at least two transmitting and receiving units, each having at least two antenna elements.

In the method described here, in a method step S10 the environmental information with regard to at least the partial environment of the radar system is specified taking into account a plurality of radar signals transmitted and received by means of the radar system. The specification of the environmental information is also carried out with additional consideration of a predetermined evaluation program. As environmental information, for example a relevant distance of at least one object in at least the partial environment of the radar system in relation to the radar system, a relative speed of the at least one object in relation to the radar system, and a relevant angle of a position of the at least one object with regard to a spatial direction provided to the radar system can be specified. The evaluation program can be optimized before the radar system is commissioned, by means of at least one calibration measurement with regard to the radar system.

During operation of the radar system, at least the method steps S1 to S3 already explained above are then carried out at least once in order to specify the alignment information with regard to the relative tilt of the relevant first transmitting and receiving unit of the radar system in relation to the relevant second transmitting and receiving unit of the radar system and/or the relevant absolute tilt of each transmitting and receiving unit of the radar system with respect to the predetermined target alignment.

In a further method step S11, the evaluation program is then redefined taking into account the at least one specified relative tilt of the relative first transmitting and receiving unit of the radar system in relation to the relevant second transmitting and receiving unit of the radar system and/or the relevant specified absolute tilt of each transmitting and receiving unit of the radar system with respect to the predetermined target alignment.

For monostatic as well as bistatic evaluations involving the tilted sensor(s), the ascertained relative tilt angle or (1, n) can be converted into a phase difference at the virtual channels of the sensor or sensor system. Using these correction values, a correction matrix can be created having the same dimension as the calibration matrix of the sensor or sensor system, which is then multiplied by point-wise multiplication onto the calibration matrix. Alternatively, the estimated angle can also be corrected by the known tilt angle based on the angle values already ascertained incorrectly. In this way, influences and effects of the relevant tilt can be corrected when the method step S10 is repeated at a later date.

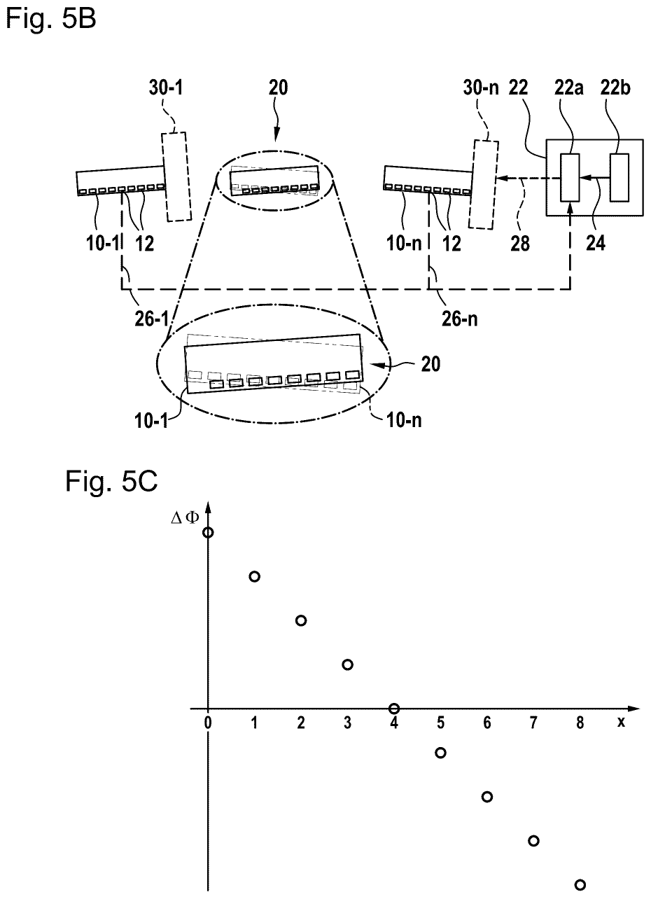

FIG. 5A to 5C are schematic partial representations of a radar system equipped with at least two transmitting and receiving units, each having at least two antenna elements, and a coordinate system for explaining an embodiment of a computer device interacting therewith.

The radar system shown schematically in FIG. 5A to 5C has at least two transmitting and receiving units 10-1 to 10-n, each having at least two antenna elements 12. The computer device 22, which is also shown schematically in FIGS. 5A and 5B, can optionally be a sub-unit of the radar system or a device spatially separated from the radar system and interacting therewith. For example, the radar system may be a radar sensor system and/or a cooperative radar sensor system.

As can be seen in FIG. 5A, all the transmitting and receiving units 10-1 to 10-n of the radar system can be tilt-free such that an alignment of each of the transmitting and receiving units 10-1 to 10-n corresponds to a predetermined target alignment. For example, for the at least two transmitting and receiving units 10-1 to 10-n, an alignment may be preferred in which a relevant main transmitting and main receiving direction 14-1 to 14-n of the at least two transmitting and receiving units 10-1 to 10-n is aligned parallel to a predetermined target direction 16. As illustrated in the projection 20 in FIG. 5A, in the case of the two transmitting and receiving units 10-1 and 10-n being present without a tilt, the two projections or virtual bistatic sensors 10-1 10-n completely overlap. This can also be described as the virtual bistatic antenna elements lying directly on top of each other.

In contrast, in the example of FIG. 5B, at least one of the two transmitting and receiving units 10-1 and 10-n is deflected/rotated out of its predetermined target alignment, which is why the two bistatic virtual sensors do not overlap in the projection 20 of the two transmitting and receiving units 10-1 and 10-n. For better understanding, the projection 20 is shown enlarged in FIG. 5B.

The computer device 22 has an electronic device 22a which is designed and/or programmed such that, by means of the electronic device 22a, from a plurality of radar signals transmitted and received by means of the radar system, at least one first radar signal transmitted by a first transmitting and receiving unit 10-1 or 10-n of the radar system, reflected at an object position outside the radar system and received by a second transmitting and receiving unit 10-1 or 10-n of the radar system, and a respectively associated second radar signal transmitted by the second transmitting and receiving unit 10-1 or 10-n, reflected at the object position and received by the first transmitting and receiving unit, can be/are selected. The at least one first radar signal and the respectively associated second radar signal are signals for which it can be recognized or read out by means of information 24 stored on a storage unit 22b of the computer device 22 that, in the case of the transmitting and receiving units 10-1 and 10-n of the radar system being present without a tilt, a probable first optical length of a first signal path of the relevant first radar signal is equal to a probable second optical length of a second signal path of the relevant second radar signal. In addition, the electronic device 22a is additionally designed and/or programmed such that, by means of the electronic device 22a, taking into account a self-ascertained or provided phase difference ΔΦ between the relevant first radar signal and the relevant second radar signal, alignment information with regard to a relative tilt of the first transmitting and receiving unit 10-1 or 10-n in relation to the second transmitting and receiving unit 10-1 or 10-n can be/is specified. For example, the electronic device 22a can be designed/programmed to determine the relevant phase difference ΔΦ based on data 26-1 and 26-n of the transmitting and receiving units 10-1 and 10-n of the radar system, and to further evaluate this for specifying the alignment information. This is shown schematically by means of the coordinate system of FIG. 5C of which the abscissa represents the positions x of the virtual antenna elements of the virtual bistatic sensor/the projection and of which the ordinate represents the ascertained phase difference ΔΦ. The phase difference ΔΦ can in particular be a phase difference ΔΦ of complex spectral values between the relevant first radar signal and the relevant second radar signal.

The use of two or more antenna elements and thus positions of the virtual, redundant antenna elements in x is particularly advantageous here, since at least two redundant virtual antenna positions are required to detect phase jumps of 360° and the robustness of the determination of the tilt increases with a higher number of antenna elements.

As an advantageous development, the electronic device 22a can also be designed/programmed to carry out the method steps explained above. In particular, by means of the electronic device 22, at least one control signal 28 can be/is output to a separate alignment device 30-1 and 30-n of the relevant transmitting and receiving unit 10-1 and 10-n for at least one of the transmitting and receiving units 10-1 and 10-n, taking into account the specified alignment information with regard to their relevant absolute tilt with respect to the predetermined target alignment, such that an actual alignment of the relevant transmitting and receiving unit 10-1 and 10-n can be/is adjusted by means of the controlled alignment device 30-1 and 30-n in accordance with the target alignment. The relevant alignment device 30-1 and 30-n can be understood as an actuator, such as an actuator having a stepper motor. However, as explained above, the electronic device 22a can also carry out the correction without using such an actuator.

1-14. (canceled)

15. A computer device for a radar system equipped with at least two transmitting and receiving units, each having at least two antenna elements, the computer device comprising:
an electronic device configured such that, by using the electronic device, from a plurality of radar signals transmitted and received using the radar system, at least one first radar signal transmitted by a first transmitting and receiving unit of the radar system, reflected at an object position outside the radar system and received by a second transmitting and receiving unit of the radar system, and in each case one second radar signal transmitted by the second transmitting and receiving unit, reflected at the object position and received by the first transmitting and receiving unit, can be selected, for which it can be recognized or read out using information stored on a storage unit of the computer device that, in the case of the transmitting and receiving units of the radar system being present without a tilt, a probable first optical length of a first signal path of the first radar signal is equal to a probable second optical length of a second signal path of the second radar signal;
wherein the electronic device is additionally configured such that, using the electronic device, taking into account a self-ascertained or provided phase difference between the first radar signal and the second radar signal, alignment information with regard to a relative tilt of the first transmitting and receiving unit in relation to the second transmitting and receiving unit can be specified.

16. The computer device according to claim 15, wherein the radar system is equipped with n transmitting and receiving units, each having at least two antenna elements, with n being a natural number greater than or equal to 3, the electronic device being configured such that, using the electronic device, from the plurality of radar signals transmitted and received using the radar system, for each of the n transmitting and receiving units as a relevant first transmitting and receiving unit and each of the n−1 further transmitting and receiving units as a relevant second receiving unit, a relevant first radar signal and a relevant second radar signal can be selected, for which it can be recognized or read out using the stored information that, in the case of the transmitting and receiving units of the radar system being present without a tilt, a probable first optical length of a relevant first signal path of the relevant first radar signal is equal to a probable second optical length of a relevant second signal path of the relevant second radar signal, and using the electronic device, taking into account a relevant phase difference between the relevant first radar signal and the relevant second radar signal the alignment information with regard to a relevant relative tilt of the relevant first transmitting and receiving unit in relation to the relevant second transmitting and receiving unit can be specified.

17. The computer device according to claim 16, wherein the electronic device is configured such that, if for at least two transmitting and receiving units a relative tilt with respect to one another equal to zero is specified as at least part of the alignment information, using the electronic device at least one of the at least two transmitting and receiving units with the relative tilt with respect to one another equal to zero can be selected as a reference unit, an absolute tilt of the at least one reference unit with respect to a predetermined target alignment equal to zero can be specified as part of the alignment information, and, if at least one of the transmitting and receiving units is not selected as a reference unit, a relative tilt of the at least one transmitting and receiving unit not selected as a reference unit in relation to the at least one reference unit can be specified as an absolute tilt of the relevant transmitting and receiving unit with respect to the predetermined target alignment as part of the alignment information.

18. The computer device according to claim 17, wherein the electronic device is configured such that, using the electronic device, at least one control signal can be output to a separate alignment device of the relevant transmitting and receiving unit for at least one of the transmitting and receiving units, taking into account the specified alignment information with regard to their relevant absolute tilt with respect to the predetermined target alignment, such that an actual alignment of the relevant transmitting and receiving unit can be adjusted using the controlled alignment device in accordance with the target alignment.

19. The computer device according to claim 16, wherein the electronic device is configured such that environmental information with regard to at least a partial environment of the radar system can be specified using the electronic device, taking into account the plurality of radar signals transmitted and received using the radar system and additionally taking into account a predetermined evaluation program, and wherein the evaluation program can be redefined using the electronic device taking into account the specified alignment information with respect to the relative tilt of the relevant first transmitting and receiving unit in relation to the relevant second transmitting and receiving unit and/or with regard to the relevant absolute tilt of each transmitting and receiving unit with respect to a predetermined target orientation.

20. The computer device according to claim 15, wherein the first radar signal is emitted by a first antenna element of the first transmitting and receiving unit, reflected at an object position and received by a second antenna element of the second transmitting and receiving unit and the second radar signal is emitted by a third antenna element of the second transmitting and receiving unit, reflected at the object position and received by a fourth antenna element of the first transmitting and receiving unit.

21. The computer device according to claim 20, wherein, in the case of the first transmitting and receiving unit and the second transmitting and receiving unit being present without a tilt, a first vector from the first antenna element of the first transmitting and receiving unit to the fourth antenna element of the first transmitting and receiving unit is equal to a second vector from the third antenna element of the second transmitting and receiving unit to the second antenna element of the second transmitting and receiving unit.

22. A radar system comprising:
at least two transmitting and receiving units, each having at least two antenna elements; and
a computer device including:
an electronic device configured such that, by using the electronic device, from a plurality of radar signals transmitted and received using the radar system, at least one first radar signal transmitted by a first transmitting and receiving unit of the radar system, reflected at an object position outside the radar system and received by a second transmitting and receiving unit of the radar system, and in each case one second radar signal transmitted by the second transmitting and receiving unit, reflected at the object position and received by the first transmitting and receiving unit, can be selected, for which it can be recognized or read out using information stored on a storage unit of the computer device that, in the case of the transmitting and receiving units of the radar system being present without a tilt, a probable first optical length of a first signal path of the first radar signal is equal to a probable second optical length of a second signal path of the second radar signal,
wherein the electronic device is additionally configured such that, using the electronic device, taking into account a self-ascertained or provided phase difference between the first radar signal and the second radar signal, alignment information with regard to a relative tilt of the first transmitting and receiving unit in relation to the second transmitting and receiving unit can be specified.

23. The radar system according to claim 22, wherein the radar system is a radar sensor system and/or a cooperative radar sensor system.

24. A method for examining a radar system equipped with at least two transmitting and receiving units, each having at least two antenna elements, the method comprising the following steps:
selecting at least one first radar signal, which is emitted by a first transmitting and receiving unit of the radar system, reflected at an object position outside the radar system and received by a second transmitting and receiving unit of the radar system, and in each case a second radar signal, which is emitted by the second transmitting and receiving unit, reflected at the object position and received by the first transmitting and receiving unit, from a plurality of radar signals transmitted and received using the radar system such that, in the case of the transmitting and receiving units of the radar system being present without a tilt, a probable first optical length of a first signal path of the first radar signal is equal to a probable second optical length of a second signal path of the second radar signal;
ascertaining a phase difference between the first radar signal and the second radar signal; and
specifying alignment information with regard to a relative tilt of the first transmitting and receiving unit in relation to the second transmitting and receiving unit, taking into account the ascertained phase difference.

25. The method according to claim 24, wherein the radar system is equipped with n transmitting and receiving units, each having at least two antenna elements, with n being a natural number greater than or equal to 3, wherein from the plurality of radar signals transmitted and received using of the radar system, for each of the n transmitting and receiving units as a relevant first transmitting and receiving unit and each of the n−1 further transmitting and receiving units as a relevant second receiving unit, a relevant first radar signal and a relevant second radar signal are selected such that, in the case of the transmitting and receiving units of the radar system being present without a tilt, a probable first optical length of a relevant first signal path of the relevant first radar signal is equal to a probable second optical length of a relevant second signal path of the relevant second radar signal, and taking into account a relevant phase difference between the relevant first radar signal and the relevant second radar signal, the alignment information with regard to the relevant relative tilt of the relevant first transmitting and receiving unit in relation to the relevant second transmitting and receiving unit is specified.

26. The method according to claim 25, wherein, when, for at least two of the transmitting and receiving units, a relative tilt with respect to one another equal to zero is specified as at least part of the alignment information, at least one of the at least two transmitting and receiving units with the relative tilt with respect to one another equal to zero is selected as a reference unit, an absolute tilt of the at least one reference unit with respect to a predetermined target alignment equal to zero is specified as part of the alignment information, and, when at least one of the transmitting and receiving units is not selected as a reference unit, a relative tilt of the at least one transmitting and receiving unit not selected as a reference unit in relation to the at least one reference unit is specified as an absolute tilt of the relevant transmitting and receiving unit with respect to a predetermined target alignment as part of the alignment information.

27. The method according to claim 24, further comprising:
outputting at least one control signal for at least one of the transmitting and receiving units to a separate alignment device of the transmitting and receiving unit taking into account the specified alignment information with regard to their relevant absolute tilt with respect to a predetermined target alignment, such that an actual alignment of the transmitting and receiving unit is adjusted using the controlled alignment device in accordance with the target alignment.

28. A method for determining environmental information with regard to at least a partial environment of a radar system equipped with at least two transmitting and receiving units, each having at least two antenna elements, the method comprising the following steps:
specifying the environmental information with regard to at least the partial environment of the radar system, taking into account a plurality of radar signals transmitted and received using the radar system and additionally taking into account a predetermined evaluation program;
examining the radar system by:
selecting at least one first radar signal, which is emitted by a first transmitting and receiving unit of the radar system, reflected at an object position outside the radar system and received by a second transmitting and receiving unit of the radar system, and in each case a second radar signal, which is emitted by the second transmitting and receiving unit, reflected at the object position and received by the first transmitting and receiving unit, from a plurality of radar signals transmitted and received using the radar system such that, in the case of the transmitting and receiving units of the radar system being present without a tilt, a probable first optical length of a first signal path of the first radar signal is equal to a probable second optical length of a second signal path of the second radar signal,
ascertaining a phase difference between the first radar signal and the second radar signal, and
specifying alignment information with regard to a relative tilt of the first transmitting and receiving unit in relation to the second transmitting and receiving unit, taking into account the ascertained phase difference; and
redefining the evaluation program taking into account the specified alignment information with regard to the relative tilt of the first transmitting and receiving unit in relation to the second transmitting and receiving unit and/or with regard to a relevant absolute tilt of each transmitting and receiving unit with respect to a predetermined target alignment.
